(19) United States
(12) Patent Application Publication
(10) Pub. No.: US 2023/0039767 A1
(43) Pub. Date: Feb. 9, 2023

(54) Imaging Method and System Based on Wise-pixels with Valved Modulation

(71) Applicant: Congying SUI, Hong Kong (HK)

(72) Inventors: Yunhui LIU, Hong Kong (HK); Congying SUI, Hong Kong (HK)

(21) Appl. No.: 17/816,726

(22) Filed: Aug. 2, 2022

(30) Foreign Application Priority Data
Aug. 3, 2021 (HK) 32021035988.3

(51) Int. Cl. H04N 5/341; H04N 5/3745; H04N 13/275

(52) U.S. Cl. CPC H04N 5/341; H04N 5/37455; H04N 13/275

(57) ABSTRACT

This disclosure presents a novel smart CMOS imaging sensor and the methods and system for imaging of an object using the smart CMOS imaging sensor. A CMOS-implemented 3D imaging system compromises a wise-pixels-containing imaging sensor and a scanning light point or beam to achieve 3D shape reconstruction, by recording performance of each wise-pixel to the incident light over the period of “valve modulation”. The “valve modulation” is a one-time process of accumulation and release of charges. A frame period comprises multiple valve modulations. In the “frame period”, each wise-pixel will repeat the process that temporarily stores the light intensity, and then release, along with a selection of preferred intensity (e.g. the globally maximum intensity, or the locally maximum intensities, and or the intensities above a certain threshold) during the whole frame period, and the selected intensity and the corresponding time will be exported to the computing units. The selection of the different preferred light intensities is implemented by memory-based, threshold-based, and difference-based approaches, respectively. The obtained maximum intensity and time information can be used to reconstruct 3D geometric information of the surface of the object scanned by moving light source.

### CROSS-REFERENCE TO RELATED APPLICATIONS

This application claims priority to Hong Kong Patent Application No. 32021035988.3 with a filing date of Aug. 3, 2021. The content of the aforementioned application, including any intervening amendments thereto, are incorporated herein by reference.

### TECHNICAL FIELD

The present disclosure generally relates to the fields of smart CMOS imaging sensors and three-dimensional (3D) shape reconstruction and measurement. More particularly, the disclosure relates to a novel smart CMOS imaging sensor, a structured-light 3D reconstruction imaging system and methods for 3D shape reconstruction.

### BACKGROUND

For traditional image sensors, each pixel records the integration of the incident light intensity over a period of time (known as exposure time). Such integration may lead to the missing of important information. For example, when a laser line sweeps across the image sensor during image acquisition, the output image only consists of pixels with uniform illuminance. However, the time instant when the laser illuminates a certain pixel is unknown. In some cases such as 3D shape reconstruction using laser scanning, the time information is very important.

To solve this problem, researchers have proposed many methods, for example, projecting multiple patterns or capturing multiple images, which largely increases the measurement time and makes it unsuitable for 3D reconstruction of moving objects.

### SUMMARY

One aspect of the disclosure provides an imaging method based on wise-pixels with valved modulation. The method includes valve modulations by one or more wise-pixels in one or more image sensors in an image sensor during a frame period, wherein, a valve modulation is a one-time process of integrating the light and resetting; high intensity selecting, by one or more wise-pixels in multiple valve modulations, the intensities that is corresponding to bright light based on some certain conditions; time instant outputting, by the one or more wise-pixels, the time information associated with the selected light intensity during the frame period.

Implementations of the disclosure may include one or more of the following optional features. In some implementations, the high intensity selecting is based on one or more of: difference-based intensity comparison; memory-based intensity comparison; or threshold-based intensity extraction.

In some implementations, in a case of difference-based intensity comparison method, high intensity-selection by the one or more wise-pixels comprising: for each wise-pixel, calculating the difference of intensity between the current valve modulation and the previous one; detecting, by the wise-pixel, local maximum intensities of incident light based the difference of intensity; and outputting the time instans of the wise-pixel when the local maximum is detected or outputting the time instants of the wise-pixel when the local maximum is detected along with the location of the wise-pixel, or outputting the time instants of the wise-pixel when the local maximum is detected along with the location of the wise-pixel and the local maximum intensity. When the signs of the two difference values change from positive to negative, and the absolute value of the two differences are larger than a certain value, the intensity of the pixel reaches the local maximum at the middle valve modulation.

In some implementations, in a case of memory-based intensity comparison, high intensity-selection by the one or more wise-pixels comprising: for each wise-pixel, comparing the current light intensity and the previous maximum intensity, if the current light intensity is larger than the previous maximum intensity, the maximum intensity is replaced by the current light intensity; and outputting the time instant of the wise-pixel when the global maximum of the incident light is detected during a frame period, or outputting the time instant of the wise-pixel when the global maximum of the incident light is detected along with the the globally maximum intensity during a frame period. The temporal maximum intensity of the incident light in all the previous valve modulations during intensity-selection is stored in the first storage unit; the time instant when the maximum intensity information is detected is stored in the second storage unit.

In some implementations, in a case of threshold-based intensity comparison method, high intensity-selection by the one or more wise-pixels comprising: using a threshold to extract intensities for all the wise-pixels whose intensities are higher than the threshold at each valve modulation; and outputting the time instant of the wise-pixel when the intensity is larger than the threshold during a frame period, or outputting the time instant when the selecting intensity is larger than the threshold along with the selecting intensity during a frame period. The threshold is obtained by comparing the intensities of all the wise-pixels in the column in a valve modulation. In some implementations, the threshold is determined using the maxim intensity in each wise-pixel column in a valve modulation.

In some implementations, the method further comprising processing the wise-pixels row by row using column processing circuitries. Buffering the data for AD conversion, wherein the detected analog intensity is pushed into a buffer before converted into digital values; and the length of the buffer may be less than the number of rows. Wherein the buffer works in such a way that once the lower layer of the buffer is empty, the data in the upper layer of buffer is pushed into the lower layer. In some other implementations, buffering the data for I/O, wherein the data are pushed into memory buffers before exporting; and the length of the buffer may be less than the number of rows.

In some implementations, the method further comprising storing the data generated during intensity selection using a storage unit, wherein the storage unit is internal, wherein the storage unit is inside the area of pixel; or the storage unit is external, and a circuitry is used to access the memory; the stored data is analog data, the data is converted to digital data only when the data is about to be outputted; or the stored data is digital data, additional ADC and/or DAC is used to store and/or access the data in the storage unit. In case that the selected intensity is converted to digital data, the intensity selection and AD conversion share a common device, so that intensity selection and AD conversion is operated simultaneously, wherein the AD conversion is SAR ADC.

Another aspect of the disclosure provides an imaging sensor, wherein the image sensor comprises one or more wise-pixels, wherein the wise-pixel is controlled to integrate the light and reset by valve modulation multiple times in a frame period; the image sensor selects high intensities based on some certain conditions during multiple valve modulations; the image sensor exports time information when the selected intensities are detected during a frame period.

Implementations of the disclosure may include one or more of the following optional features. In some implementations, the intensity selection is based on one or more of difference-based intensity comparison; memory-based intensity comparison; or threshold-based intensity extraction.

In a case of difference-based intensity comparison, high intensity-selection by the one or more wise-pixels, comprising for each wise-pixel, calculating the difference of intensity between the current valve modulation and the previous one; detecting, by the wise-pixel, local maximum intensities of incident light based the difference of intensity; and outputting the time instants of the wise-pixel when the local maximum is detected, or outputting the time instants of the wise-pixel when the local maximum is detected along with the location of the wise-pixel, or outputting the time instants of the wise-pixel when the local maximum is detected along with the location of the wise-pixel and the local maximum intensity.

In some implementations, wherein, when the signs of the two difference values change from positive to negative, and absolute values of the two differences are larger than a certain value, the intensity of the pixel reaches the local maximum at the middle valve modulation. In a case of memory-based intensity comparison, high intensity-selection by the one or more wise-pixels comprising: for each wise-pixel, comparing the current light intensity and the previous maximum intensity, if the current light intensity is larger than the previous maximum intensity, the maximum intensity is replaced by the current light intensity; and outputting the time instant of the wise-pixel when the global maximum of the incident light is detected during a frame period, or outputting the globally maximum intensity of the wise-pixel along with the time instant when the global maximum of the incident light is detected during a frame period. Wherein, the temporal maximum intensity of the incident light in all the previous valve modulations during intensity-selection is stored in the first storage unit; the time instant when the temporal maximum intensity information is detected is stored in the second storage unit.

In some implementations, in a case of threshold-based intensity comparison, high intensity-selection by the one or more wise-pixels comprising: using a threshold to extract intensities for all the wise-pixels whose intensities are higher than the threshold at each valve modulation; and outputting the time instant of the wise-pixel when the intensity is larger than the threshold during a frame period, or outputting the time instant when the selecting intensity is larger than the threshold along with the selecting intensity during a frame period. The threshold is obtained by comparing the intensities of all the wise-pixels in the column in a valve modulation; wherein the threshold is determined using the maxim intensity in each wise-pixel column in a valve modulation.

In some implementations, the image sensor processes the pixels row by row; intensity selection is based on the column processing circuitry. The column processing circuitry comprising a fast ADC architecture, wherein the detected analog intensities are pushed into a buffer before they are converted into digital values; and the length of the buffer may be less than the number of rows. Wherein the buffer works in such a way that once the lower layer of the buffer is empty, the data in the upper layer of buffer is pushed into the lower layer. The column processing circuitry comprising: a fast I/O architecture, wherein the data are pushed into memory buffers before exporting; and the length of the buffer may be less than the number of rows.

In some implementations, the image sensor further comprises a storage unit to store the data during intensity selection, wherein (a) the storage unit is internal, i.e., the storage unit is inside the area of pixel; or the storage unit is external, and a circuitry is used to access the memory; (b) the stored data is analog data, the data is converted to digital data only when the data is about to be outputted; or the stored data is digital data, external ADC and/or DAC is used to store and/or access the data in the storage unit.

In some implementations, the image sensor further comprises a processing circuitry, wherein the intensity selection and AD conversion share a common device, for example, SAR ADC, so that intensity selection and AD conversion is operated simultaneously.

Another aspect of the disclosure provides an imaging method, comprising: calculating a geometry of an object scanned by featured light based on the information related to time instant or time instant along with locations and/or selected intensities of the wise-pixels in one or more image sensor as recited; time instant or time instant along with locations and/or selected intensities of the wise pixels are obtained according to the any of above methods as recited. Wherein calculating a geometry of an object scanned by featured light based on the information related to time instant or time instant along with locations and/or selected intensities of the wise pixels, comprising: forming a pixel ray by each wise-pixel and camera center; intersecting the matching wise-pixel rays in different image sensors at a point, or intersecting a matching wise-pixel ray with a surface plan of the incident light at a point; and calculating the geometry position of the point according to the calibration information of image sensors.

Another aspect of the disclosure provides an imaging system, comprising: one or more image sensors comprising one or more wise-pixels as recited above; one or more light sources; one or more computing units; wherein the one or more wise-pixels and the one or more computing units are configured to perform the method recited by the any of above methods.

### BRIEF DESCRIPTION OF THE DRAWINGS

FIG. 1 is a diagram illustrating a valve modulation in accordance with the present application.

FIG. 2 shows an example of exporting the maximum intensity and the corresponding time instant for each wise-pixel in all the valve modulations according to an embodiment of the disclosed subject matter.

FIG. 3 is a diagram that shows the intensity variation during a frame period and the selection of the adaptive threshold according to an embodiment of the disclosed subject matter.

FIG. 4 is a diagram that shows a laser line reflected on the sensor according to an embodiment of the disclosed subject matter.

FIG. 5 shows an example of exporting the time instants and the locations of the pixels reaching the local maximum intensities according to an embodiment of the disclosed subject matter.

FIG. 6 shows three consecutive bright intensities in three consecutive valve modulations of a frame period according to an embodiment of the disclosed subject matter.

FIG. 7 is a diagram that shows the smart difference-based CMOS sensor with column-based processing.

FIG. 8 is a diagram that shows the difference-based CMOS sensor without an analog buffer according to an embodiment of the disclosed subject matter.

FIG. 9 is a diagram that shows the difference-based CMOS sensor with an analog buffer according to an embodiment of the disclosed subject matter.

FIG. 10 is a diagram that shows the working principle of the analog buffer according to an embodiment of the disclosed subject matter.

FIG. 11 is a diagram that shows the logic circuit of the logic-based intensity comparison according to an embodiment of the disclosed subject matter.

FIG. 12 shows a logic circuit of the logic-based intensity comparison which holds the analog maximum light-induced signal in the circuit according to an embodiment of the disclosed subject matter.

FIG. 13 shows the memory-based smart CMOS sensor with external memory according to an embodiment of the disclosed subject matter.

FIG. 14 is a diagram that shows the smart threshold-based CMOS sensor with column-based processing and without using external memory according to an embodiment of the disclosed subject matter.

FIG. 15 shows a diagram of a 3D scanning system with a monocular camera according to an embodiment of the disclosed subject matter.

FIG. 16 shows a diagram of a 3D scanning system with dual cameras according to an embodiment of the disclosed subject matter.

FIG. 17 shows an auto-rotated galvanometer that reflects a beam of light according to an embodiment of the disclosed subject matter.

FIG. 18 shows an auto-rotated motor drives the beam of light to scan according to an embodiment of the disclosed subject matter.

FIG. 19 shows a projector that projects a moving beam of light according to an embodiment of the disclosed subject matter.

FIG. 20 shows a flowchart of the 3D scanning method with a monocular camera according to an embodiment of the disclosed subject matter.

### DETAILED DESCRIPTION

This disclosure presents a novel smart CMOS imaging sensor and the methods and system for 3D imaging of an object using the smart CMOS imaging sensor. A CMOS-implemented 3D imaging system compromises a wise-pixels-containing imaging sensor and a scanning light point or beam to achieve 3D shape reconstruction, by recording performance of each wise-pixel to the incident light over the period of “valve modulation”. The “valve modulation” is a one-time process of accumulation and release of charges. A frame period comprises multiple valve modulations. In the “frame period”, each wise-pixel will repeat the process that temporarily stores the light intensity, and then release, along with a selection of preferred intensity (e.g. the globally maximum intensity, or the locally maximum intensities, and or the intensities above a certain threshold) during the whole frame period, and the selected intensity and the corresponding time will be exported to the computing units. The selection of the different preferred light intensities is implemented by memory-based, threshold-based, and difference-based approaches, respectively. The obtained maximum intensity and time information can be used to reconstruct 3D geometric information of the surface of the object scanned by moving light source. The details of 3D imaging methods and systems using the smart CMOS imaging sensor are presented.

In illustrative implementations of this disclosure, an imaging system includes a light source that illuminates the measured region with a featured light, one or more image sensors which comprise multiple wise-pixels, and one or more computing units that calculate the 3D position of the featured light. In illustrative implementations of this disclosure, recording each wise-pixel performance to the light is modulated by the type of modulation called “Valve Modulation”.

In illustrative implementations of this disclosure, the light source generated from laser or LED light to scan the measured area could be visible or invisible, and the shape of the light source could be chosen in a wide range: a point, a line or a curve. The light generated by the light source could be either a continuous wave or discrete light pulses.

In illustrative implementations of this disclosure, the key point comes from the image sensors and the wise-pixels. The wise-pixel comprises a complementary metal-oxide-semiconductor (CMOS) pixel which may be accompanied by storage units and arithmetic units.

In illustrative implementations of this disclosure, the valve modulation consists of two states: ON state in which the pixel is exposed to the light and then the photodiode in the pixel accumulates the charges that respond to the incident light, and OFF state in which the accumulated charges are released.

In illustrative implementations of this disclosure, the valve modulation is performed on each wise-pixel with high frequency. In each valve modulation, the temporal light intensity information and the time instant are obtained. Using this information, we can know the information of light intensity variation during a frame period.

In illustrative implementations of this disclosure, the acquisition of the preferred light intensity and the corresponding time instant could be modulated by three types of methods, specifically:
(1) Difference-based intensity comparison, (2) Memory-based intensity comparison (3) Threshold-based intensity extraction.

The difference-based intensity comparison method is to detect the peak intensity of a pixel during the frame period by comparing two differences of the light intensities of the pixel in three consecutive valve modulations. When the signs of the two difference values change from positive to negative, the intensity of the pixel reaches the local maximum at the middle valve modulation. The location of the pixel will be outputted with its maximum intensity. The information on the time instant is implicated in the counting of the valve modulation. The maximum-picking process will continue to the end of the frame period, and as a result, multiple (local) maximum intensities, that occur at different time instants, may be detected for a pixel.

The memory-based intensity comparison method is to obtain the brightest (maximum) intensity and the corresponding time instant for each pixel in a frame period, which is saved in a storage unit. A frame period comprises multiple valve modulations. In each valve modulation, by comparing the incoming signal with the maximum value obtained in previous valve modulations, the values in the storage unit will or will not be updated accordingly. This process will repeat to the end of the frame period. As a result, the storage unit stores the maximum intensity (with corresponding time instant) during the frame period.

The threshold-based intensity extraction method is to use a threshold to extract and output the pixels whose intensities are higher than the threshold at each valve modulation. Only the analog signals of the detected pixels will be converted to digital signals to reduce the speed requirements of the ADC (analog-to-digital converter). The threshold may be obtained by logical operations of the analogy signals of the pixels in a column. The time instant can be obtained by counting the valve modulations. It should be noted that the maximum intensity of pixels needs to be detected using an algorithm implemented in external computing units.

In illustrative implementations of this disclosure, the computing units are for calculating the 3D geometry of the object scanned by the featured light. For each wise-pixel, from the time instant when the intensity reaches the maximum and time-trajectory of the light source, it is straightforward and simple to calculate the 3D position of the reflection point of the light wave on the object based on triangulation. Real-time 3D construction can be realized by the invented system.

The detailed description is divided into two sections. Section I describes the smart CMOS sensor. Section II presents a 3D imaging system and a 3D reconstruction method using the smart CMOS sensor.

I. Smart CMOS Sensor

I.A Overview

For traditional image sensors, each pixel records the integration of the incident light intensity over a period of time (known as exposure time). Such integration may lead to the missing of important information. For example, when a laser line sweeps across the image sensor during image acquisition, the output image only consists of pixels with uniform illuminance. However, the time instant when the laser illuminates a certain pixel is unknown. In some cases such as 3D shape reconstruction using laser scanning, the time information is very important. To solve this problem, researchers have proposed many methods, for example, projecting multiple patterns or capturing multiple images, which largely increases the measurement time and makes it unsuitable for 3D reconstruction of moving objects.

In this disclosure, we propose a novel image sensor that avoids the above problems. The image sensor has the capability to track the trajectory of the incident light on the sensor. For example, it can record the time instant when the laser is detected on the pixel and the light intensity. This function is realized by applying valve modulations on each pixel with high frequency during a frame period. In the “valve modulation”, each pixel will repeat the process that temporarily accumulates the charges responding to incident light and then releases, along with a comparison between the obtained signal and the reference signal (e.g. the maximum signal obtained from the previous valve modulations, or a threshold signal). The selected signals during a frame period and the corresponding time instants will be converted to digital signal and exported at the end of a frame period.

This disclosure has wide applications. For example, it can be applied into 3D scanning, i.e., for high-speed 3D reconstruction of targets in a scene, because the laser only requires sweeping across the targets' surface once for each measurement.

I.B Valve Modulation

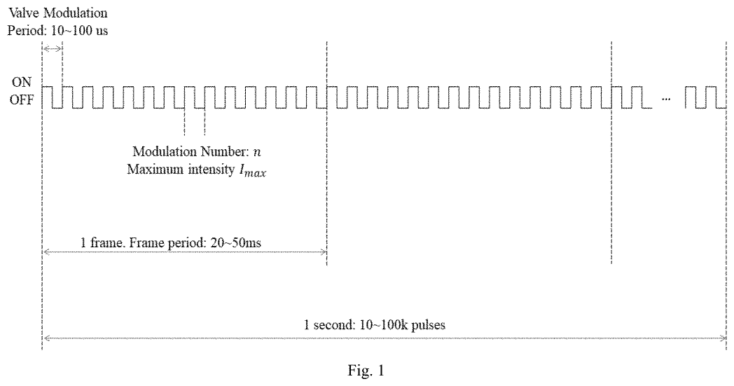

An example of valve modulation is illustrated in FIG. 1. The valve modulation consists of two states: ON and OFF. When the valve modulation is ON, the pixel is exposed to the light and the photodiode in the pixel accumulates the charges that respond to the incident light. When the valve modulation is OFF, the accumulated charges are released. The valve modulation switches with a high frequency that is much faster than the frame rate of the image system. As an example, the frame rate of a 4M-resolution image sensor is 20-50 fps, while the frequency of the valve modulation is 10 k-100 kHz.

In some cases, the valve modulation helps the sensor obtain the brightest light's intensity and the corresponding time instant. In each valve modulation period, the light intensity that corresponds to the accumulated charges is obtained. Then, the arithmetic unit (e.g. comparator) accompanied by each pixel is utilized to compare the intensity with the reference signal (e.g. the largest intensity in all the previous modulations). If the new intensity is larger, then the maximum intensity is replaced with the current one. By repeating the valve modulation and the above process, the maximum intensity and the corresponding time instant among all the valve modulations in a frame period is obtained.

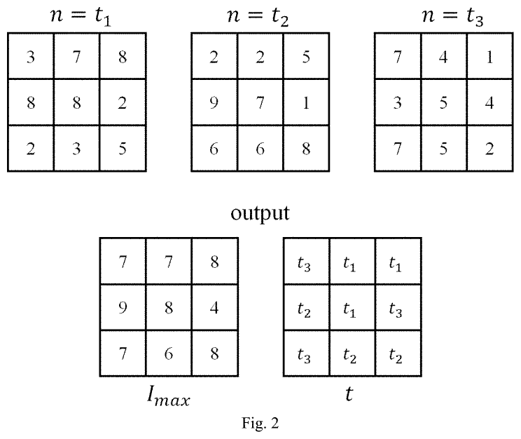

An example is illustrated in FIG. 2. Suppose there are three valve modulations in a frame period, and the time instants corresponding to the three valve modulations are t₁, t₂, t₃, respectively. The intensity values of the pixels in the three valve modulations are obtained, as shown in FIG. 2. Then the output datas of the sensor are as shown in the bottom of FIG. 2. In the first output image, a pixel's maximum intensity is recorded. The second output image demonstrates the time instants when the maximum intensities are detected.

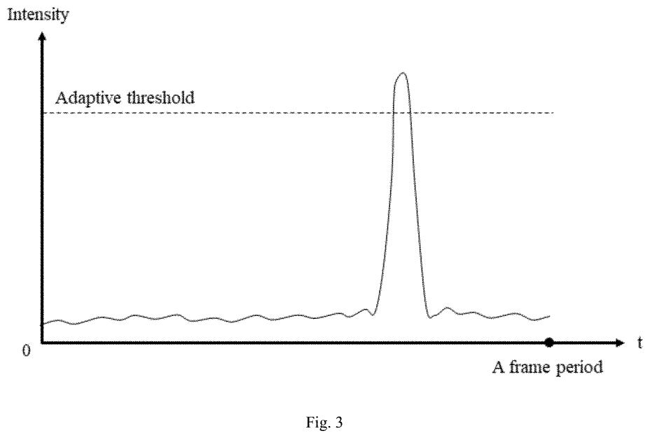

In some cases, the valve modulation can also be utilized to export the intensities and the time instants when the light intensity is above a threshold, as shown in FIG. 3. In this case, we can track the positions of the bright light, and extract the center of the laser line using software, e.g. gaussian model fit, etc. This method has a higher robustness to sensor noise than extracting the maximum intensity directly.

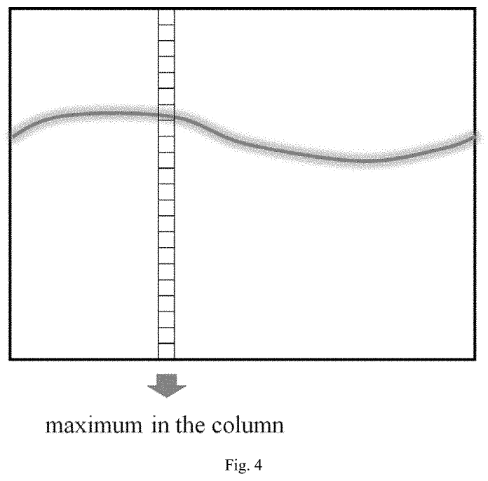

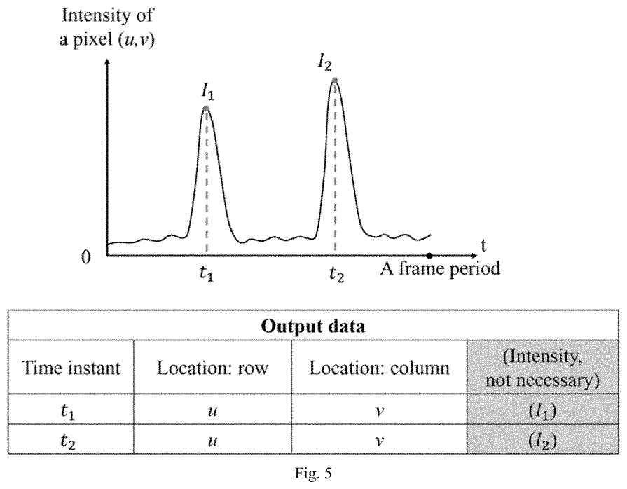

In some cases, the valve modulation can be utilized to find the time instants when the incident light on the pixels reaches the local maximum. As illustrated in FIG. 4, the difference between the current intensity and the previous intensity can be obtained by a logic circuit (e.g. comparator, etc.). Suppose the previous difference is positive while the current difference is negative, the intensity can be regarded as a peak value. Then the intensity and the corresponding time instant are exported. This method can help to handle the problem of interreflection on the measured object's surface. An example is illustrated in FIG. 5. Suppose a pixel's intensity reaches local maximum intensity at time instants: t₁ and t₂. The corresponding local maximum intensities are I₁ and I₂, respectively. Then the output data of the sensor are as shown in the bottom of FIG. 5. The output are the time instants and the locations of the pixels reaching the maximum intensities, with or without the maximum value.

I.C Difference-Based Intensity Comparison

An implementation of the disclosure is to use a difference-based method that detects all the local maximum intensities of a pixel during a frame period and the corresponding time instants using the differences of the intensities in three consecutive valve modulations.

For each pixel, there is an analog memory storing the light intensity at the previous modulation, and a one-bit digital flag S(t) indicating whether the intensity increased at the previous modulation. Denote the light intensity at the present valve modulation t by I(t) and that at the previous valve modulation t−l by I(t−1). For each wise-pixel, the CMOS imaging sensor conducts the following logic operations: i) calculate the difference δ(t=I(t)−I(t−1); ii) if δ(t≥Δ (where Δ is a threshold, which can be set from the external computing unit), set S(t)=1, save I(t) to the analog memory, and finish; iii) if δ(t)<−Δ and S(t−1)==1, the light intensity of the pixel reached the maximum at t−l, and then output the location of the pixel to the external computing unit. Since in CMOS imaging sensor the pixels are processed row by row, the location of the pixel can be represented as integer in a row. For 1 k pixels in a row, their positions can be represented by 10 bits. The maximum intensity can be saved in an analog memory. The information on the time instant is obtained from the count of valve modulations.

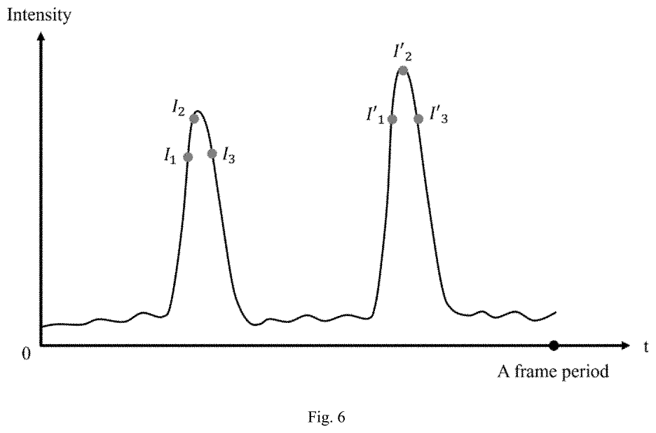

FIG. 6 is an example for illustrating the principle of this method. FIG. 6 is a graph that shows three consecutive bright intensities in three consecutive valve modulations of a frame period. Corresponding to three consecutive valve modulations, there are three consecutive light intensities I₁, I₂, I₃ (drawn in red dots). The graph shows the bright intensity obtained in the whole frame period, ignoring small fluctuations which are noises. The difference I₃−I₂ in this valve modulation will be compared with the difference I₂−I₁ obtained in last valve modulation. It is easy to understand that the presented method detects the maximum intensity.

It should be noted that the threshold Δ is an important parameter that must be tuned externally via the external computing unit. A too small value will detect pseudo maximums that are due to noises, and a large value leads to low sensitivity. Properly tuning the parameter is important to the performance of the smart CMOS imaging sensor.

It should be also pointed out that this approach, together the threshold-based method, can detect all local maximums of intensity of light incident to the pixels during a frame period. This is an important function for carrying out high-speed measurement.

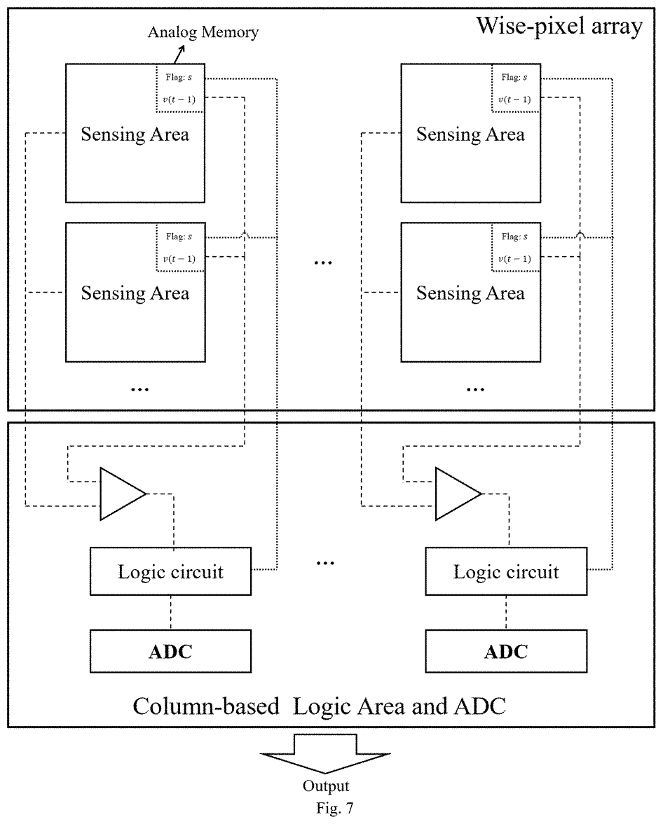

FIG. 7 is a diagram that shows the smart difference-based CMOS sensor with column-based processing.

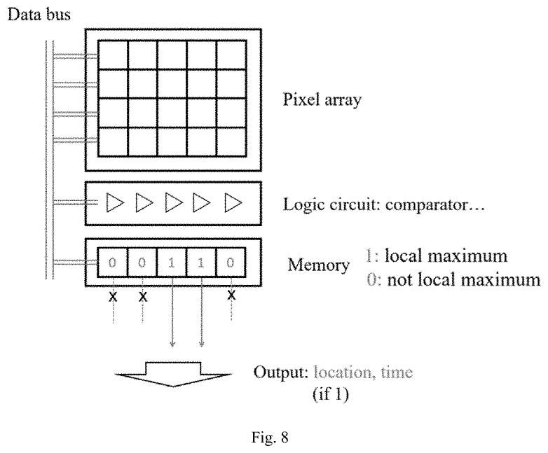

There are two possible implementations: One implementation is to just output the locations of the pixels reaching the maximum light intensity at valve modulations. The time instants are obtained from counting of the valve modulations. The maximum intensities are not outputted. This implementation does not need any ADC so as to reduce the cost and improve the speed, as shown in FIG. 8. FIG. 8 is a diagram that shows the difference-based CMOS sensor without an analog buffer. The CMOS sensor outputs the time instants and the locations of the pixels reaching the maximum intensities.

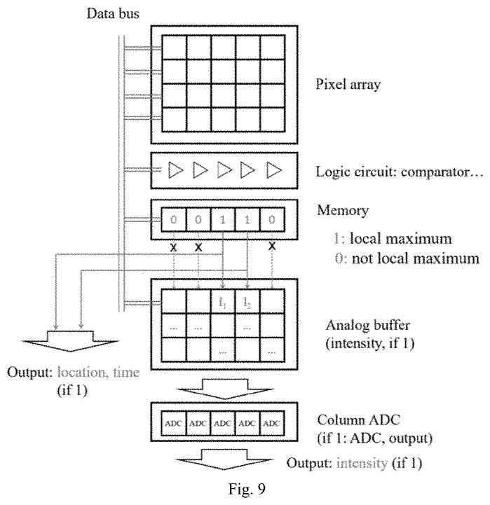

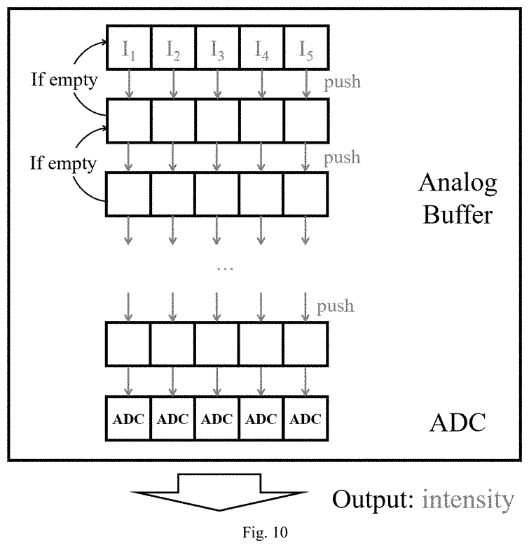

In another implementation, the intensities will be outputted in addition to the locations of the pixels, as shown in FIG. 9. FIG. 9 is a diagram that shows the difference-based CMOS sensor with an analog buffer. The CMOS sensor outputs the time instants and the locations of the pixels reaching the maximum intensities, with the maximum value. Since the ADC is carried row by row, high-speed ADC is necessary for high frequency valve modulation. It should be noted that in each column there are only a few pixels whose intensities reach the maximum at a valve modulation, as shown in FIG. 4, so it is possible to prepare an analog buffer with a short length (<10 samples) so that the row-to-row processing can be carried out without waiting for process of the ADC. Therefore, a slower ADC is sufficiently for converting a few samples in every valve modulation period. The working principle of the analog buffer is illustrated in FIG. 10. The analog local maximum intensities are first pushed into the first layer of the buffer. If the lower layer is empty, then the intensities are pushed to the next layer. The process is repeated until the data is transmitted to the last layer, where the analog intensities are converted to digital signals by ADC.

In the case when the buffer is not used, an implementation is to save all the maximum intensities in analogy memory of the pixels. The ADC is carried out one time only at the end of the frame period. In this case, the last local maximum of the light intensity is outputted for each pixel.

I.D Memory-Based Intensity Comparison

This section introduces the memory-based methods to obtain the globally maximum light intensity and the corresponding time instant for each pixel in a frame period. The basic idea is to iteratively apply valve modulation on each pixel, read the light-induced signal, and compare the signal with the maximum value obtained from the previous valve modulations. If the signal is larger than the maximum value, the maximum signal is replaced with the current one, and the time instant is recorded. The above process is repeated until the end of the frame period, then the maximum intensity in a frame period is obtained.

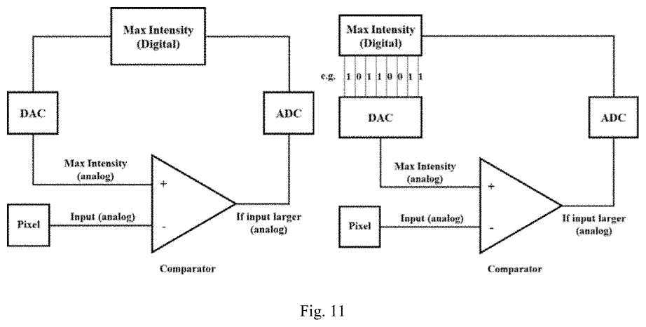

One example of the logic circuit is shown in FIG. 11. The initial value of the maximum intensity may be a user-defined number or 0. By applying a valve modulation, an analog signal is induced by exposure in the incident light. The signal (‘input’ in the FIG. 11) is compared with the analog signal of the maximum intensity by a comparator. If the input signal is larger, the signal is converted to a digital signal (ADC) and stored in a storage unit. The corresponding time instant is also recorded in a second storage unit. Then the new maximum intensity is converted to analog signal by a DAC to be compared with the next input signal. If the input signal is smaller, the signal is released without being recorded.

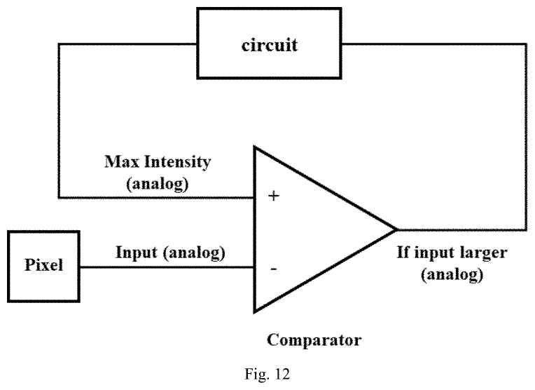

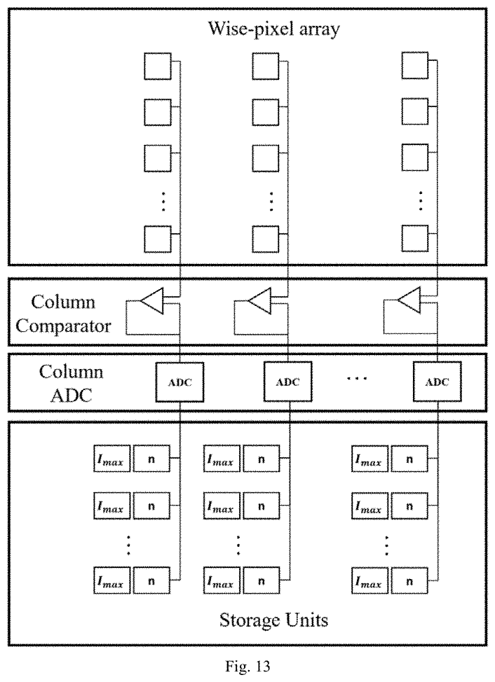

In some cases, the logic circuit is as shown in FIG. 12. FIG. 12 shows a logic circuit of the logic-based intensity comparison which holds the analog maximum light-induced signal in the circuit. The maximum signal is not required to be converted into digital signals or stored into a storage unit. After comparing the input light-induced analog signal with the maximum one, the larger signal is held by the circuit, e.g. the capacitance. The stored signal will be compared with the input signal from the next valve modulation. The analog maximum signal and the time instant will be held in the circuit until the end of the frame period. Then the signals in the same column will be converted to digital value together and stored in the storage units, as shown in FIG. 13.

It should be noted that the comparator can be implemented outside like column-based ADC. In other words, a column-based comparator can be used for all the pixels. An even simpler implementation is to use the comparator in the column-based ADC.

The memory unit can be implemented in the pixel. External memory (e.g. SRAM) can also be used for saving the intensities and the time instants. A logic circuit needs to be implemented to access the external memory.

I.E Threshold-Based Intensity Extraction

This section introduces a column-based threshold-based method to extract all pixels whose intensity in a valve modulation is above an adaptive threshold. A method for determining the adaptive threshold is also given.

The key point of this method is to determine the adaptive threshold. The clue is that when a line or curve light source is used, the line or curve light must scan in the direction vertical to column so that only a few pixels (theoretically, one pixel) reach the maximum intensity in each valve modulation. Then by setting the threshold below or equal to the maximum value, all the pixels whose intensity are above the threshold in the column in each valve modulation are detected and outputted as digital signals via ADC (analog-to-digital convertor). It should be noted that the time instant can be obtained by counting the valve modulation.

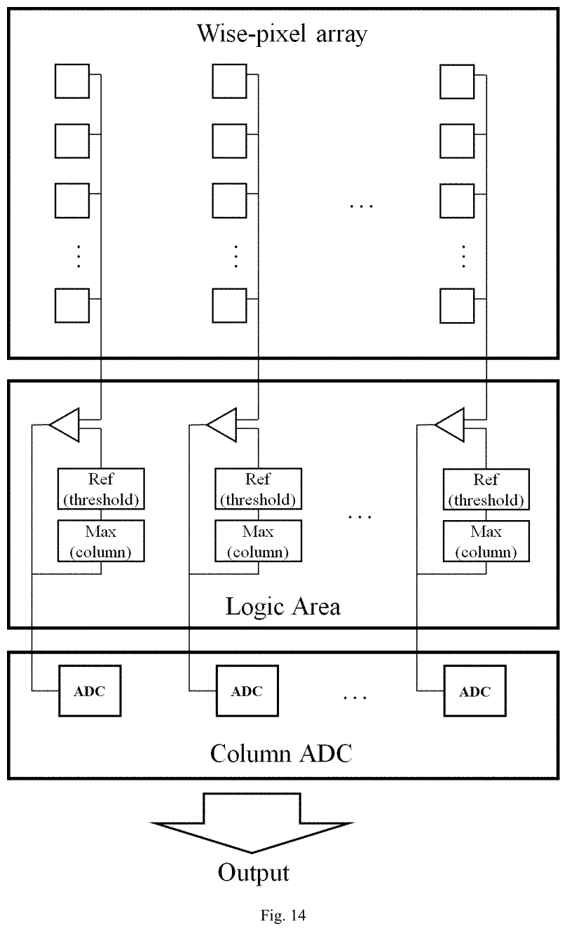

As illustrated in FIG. 4, in a valve modulation period, a laser line is reflected onto the sensor. Thus, in the column direction vertical to the laser line, a brightest intensity Iₘₐₓcan be found by comparing all the light-induced signals in each pixel of the column, as shown in FIG. 14. FIG. 14 is a diagram that shows the smart threshold-based CMOS sensor with column-based processing and without using external memory. The adaptive threshold can be selected as αIₘₐₓ, where αis a factor ranging from [0,1]. For example, we can set it as 0.8 to remove the majority of the disturbing light. Then, the analog signals in the column that are larger than the threshold are exported to ADC, and then, together with the positions of the detected pixels, are outputted to the external computing units.

I.F Speed and Bandwidth Requirements

A critical issue for the valve modulation is the speed of the comparisons, ADC, and output bandwidth for the high frequency.

If all the logic operations are performed at the pixel level in parallel, speeds of the comparator, ADC, memory, and output are not concerns. However, pixel-based implementation will increase the cost and reduce the sensing area of a pixel, which are not desirable.

In column-based implementation, the speeds are important. The memory-based approach requires high speeds of comparators, ADC and memory access, so it is not suitable for column-based implementation. The threshold-based approach and the difference-based method require a high speed comparator. When the analog buffer is implemented, the high speed of ADC is not required for only a small percentage of the pixels in a column needs to be converted to digital signals at each valve modulation. It is necessary to have a large output bandwidth to the external computing units. Assume that resolution of an image is M*N and the frequency of the valve modulation is f. The column-based comparator's speeds must be faster than N*f. Assume that the buffer is used, the speed of the ADC is N*f*p, where p is the percentage of the pixels whose intensities are larger than the threshold or reach the local maximum. The output bandwidth is the M*N*f * p*(8+ln N). For example, when M=2048, N=2048, and f=20 kHz, the comparator's speed is 40 MHz; the ADC's speed is 400 kHz for p=0.01; and the output bandwidth is 15.2GBPS for p=0.01.

It should be noted that the output bandwidth requirement for the difference-based method is the peak value. When a line light source scans the surface of an object, theoretically each pixel reaches the maximum one time only. For a frame period, regardless of the frequency of the valve modulation, only M*N samples need to be outputted. Therefore, adding some output buffering can reduce the output bandwidth requirements

II. 3D Reconstruction Using the Smart CMOS Sensor

II. A System Configuration

In illustrative implementations, the moving beam or pulses of light can be produced in different methods. For instance, there are several types of light sources that can produce the moving beam or pulses of light: (a) auto-rotated galvanometer; (b) projector; (c) auto-rotated motor. The light source is not limited to laser light.

II.B 3D Reconstruction Methods

In some 3D reconstruction methods of this disclosure, a monocular system shown in FIG. 11 can be used. The light beam scans the measured area and the angle position of the light beam can be measured by the time information extracted from the wise-pixel's output data and high resolution sensors. Then the light beam whose direction is known, the wise-pixel, and the optical centre of the camera form a triangulation system, which can be used to calculate the 3D position of the reflection point of the light beam.

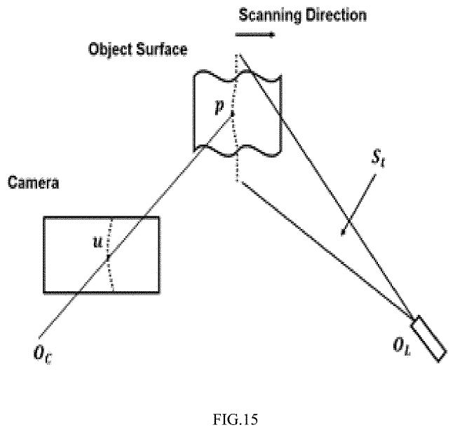

In some implementations, the diagram of a 3D scanning system with the monocular camera is shown in FIG. 15. For the wise-pixel u, the maximum light intensity and the corresponding time information t are extracted from the output data. According to the calibration data, the surface plane of the incident light Sₜ can be determined. In the camera model, the center of the camera O_{c} is pre-known. Then the wise-pixel ray O_{c}u may intersect with plane Sₜ at point p. According to the line-surface intersection equation, the 3D position of point p is determined. Therefore, all the wise-pixels can be calculated to acquire the 3D model of the measured scene.

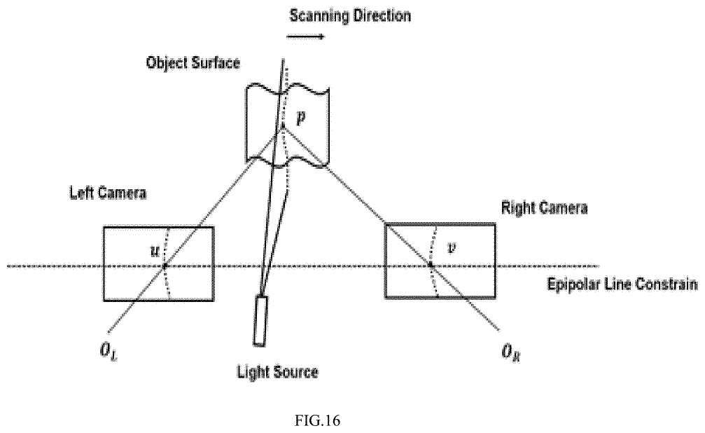

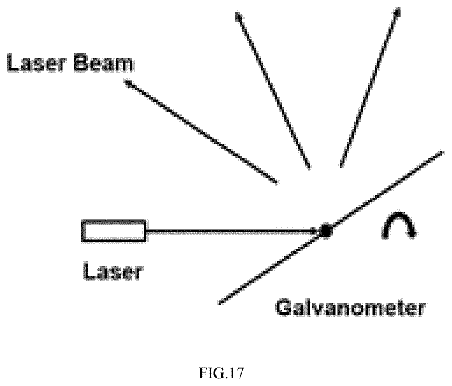

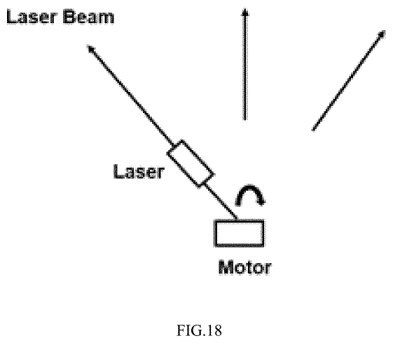

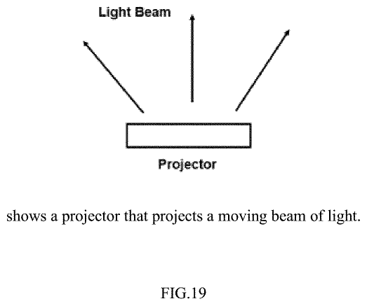

In some implementations, the diagram of a 3D scanning system with dual cameras is shown in FIG. 16. For the wise-pixel u in the left camera, the corresponding time instant t of the maximum intensity is extracted from the output data. In the epipolar line constraint, the matching pixel v in the right camera can be found by searching it in the epipolar line. The time information tᵤ of the wise-pixel u should be as close as the time information tᵥ of the wise-pixel v. Then the wise-pixel ray O_{L}u and the wise-pixel ray O_{R}v can intersect at point p. According to the line-line intersection equation, the 3D position of point p is determined. Therefore, all the wise-pixels can be calculated to acquire the 3D model of the measured scene. FIG. 17 shows an auto-rotated galvanometer that reflects a beam of light. FIG. 18 shows an auto-rotated motor drives the beam of light to scan. FIG. 19 shows a projector that projects a moving beam of light.

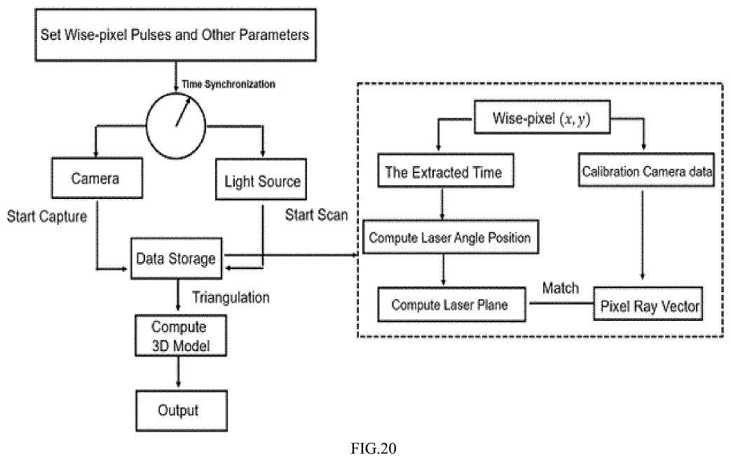

FIG. 20 is a flowchart of the 3D scanning method with a monocular camera. Each wise-pixel is calculated separately. In the example shown in FIG. 20, parameters such as the pulses of wise-pixel and threshold of the wise-pixel intensity are set. When the timer is activated, it triggers the sensor wise-pixel start perceiving light and the light source starts scanning. When the data transfers to the data storage, for each wise-pixel (x,y), the output data time is extracted to compute the laser plane. Then the mentioned triangulation method of 3D scanning system with the monocular camera can be applied to acquire the 3D model of the scene.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

Example 1: An image sensor, wherein:

(a) The image sensor comprises multiple wise-pixels;
(b) Each wise-pixel is controlled in such a way that the response to light of each wise-pixel changes over time;
(c) The wise-pixel records the information related to light illumination and time.

Example 2: The image sensor of example 1, wherein each wise-pixel comprises a complementary metal-oxide-semiconductor (CMOS) pixel.

Example 3: The image sensor of example 2, wherein the wise-pixel is controlled in such a way that

(a) During each frame period, the charges responded to the incident light on the photodiode accumulate and release multiple times;
(b) Accumulation and release of the charges are performed in turn at the fast sensing frequency.
An entire process of accumulation and release of the charges is called ‘valve modulation’. The time period corresponding to the valve modulation is called ‘valve modulation period’.

Example 4: The image sensor of example 3, wherein the wise-pixel detects the time instants when the pixel's intensity reaches local maximum.

Example 5: The image sensor of example 3, wherein the wise-pixel detects all the peak intensities, e.g. locally maximum intensities of the incident light and the corresponding time instants.

Example 6: The image sensor of example 3, wherein the wise-pixel detects the time instant of globally maximum intensity of incident light during a frame period.

Example 7: The image sensor of example 3, wherein the wise-pixel detects the globally maximum intensity of incident light during a frame period and the time instant of the global maximum.

Example 8: The image sensor of example 3, wherein the wise-pixel detects the time instants when the pixel's intensities of the incident light is brighter than a certain threshold.

Example 9: The image sensor of example 3, wherein the wise-pixel detects the intensities of the incident light that is brighter than a certain threshold and the corresponding time instants.

Example 10: The image sensor of example 3, wherein the intensity of the incident light may include the light intensity, the number of charges, the current value or voltage value.

Example 11: The image sensor of example 3, wherein the time instant may include the current time and the number of the valve modulations.

Example 12: The image sensor of example 4, wherein the image sensor detects the time instant of local maximum by calculating the intensity difference of the two successive valve modulations.

Example 13: The image sensor of example 12, wherein the image sensor further comprises arithmetic units, e.g. a comparator, a time clock counter, and a logic circuit.

Example 14: The image sensor of example 13, wherein

(a) the logic circuit of each wise-pixel computes the difference of intensity between the current valve modulation and the previous one;
(b) the logic circuit of each pixel determine the flag (e.g. 0 or 1) of the present valve modulation of the wise-pixel according to the difference and a threshold;
(c) the logic circuit of each wise-pixel determine whether or not the present intensity is a local maximum.

Example 15: The image sensor of example 14, wherein the flag of the present valve modulation is determined by: the flag is ‘0’ when the difference is negative, and the absolute difference is larger than a threshold; the flag is ‘1’ when the difference is positive, and the absolute difference is larger than a threshold.

Example 16: The image sensor of example 15, wherein the threshold is set from the external computing unit, e.g. the threshold is determined by the dark noise of the image sensor.

Example 17: The image sensor of example 16, wherein the image sensor further comprises memories. The memories record the data in such a way that:

(a) the intensity of the previous modulation is stored in a first memory;
(b) the flag of the previous modulation is stored in a second memory;

Example 18: The image sensor of example 17, wherein the memories are analog memory or digital memory.

Example 19: The image sensor of example 18, wherein the memories, the comparator and the logic circuit are located by each pixel inside the sensing area (pixel-based), behind the sensing area (multi-layer) or placed outside the sensing area (e.g. column-based).

Example 20: The image sensor of example 19, wherein the image sensor outputs the time instants when the pixel's intensity reaches local maximum, and the location of pixels that reach local maximum.

Example 21: The image sensor of example 13, wherein the image sensor further comprises ADC.

Example 22: The image sensor of example 21, wherein the ADC of the image sensor convert the analog intensity values into digital values.

Example 23: The image sensor of example 22, wherein image sensor further outputs the local maximum intensity values.

Example 24: The image sensor of example 23, wherein the image sensor further comprises buffer, which is analog or digital.

Example 25: The image sensor of example 24, wherein the detected analog local maximum intensities are pushed into the buffer before they are converted into digital values.

Example 26: The image sensor of example 25, wherein the buffer works in such a way that once the lower layer of the buffer is empty, the data in the upper layer of buffer is pushed into the lower layer.

Example 27: The image sensor of example 26, wherein the length of the buffer may be the maximum number of peak intensity values.

Example 28: The image sensor of example 27, wherein the memories, the comparator, the logic circuit, the buffer and the ADC are located by each pixel inside the sensing area (pixel-based), behind the sensing area (multi-layer) or placed outside the sensing area (e.g. column-based).

Example 29: The image sensor of example 6, wherein the image sensor further comprises arithmetic units.

Example 30: The image sensor of example 29, wherein the arithmetic units comprise a comparator and a time clock counter.

Example 31: The image sensor of example 30, wherein for each wise-pixel, the comparator compare the incident light's intensity of the valve modulation with the maximum intensity from the previous valve modulations.

Example 32: The image sensor of example 31, wherein the maximum light intensity is obtained iteratively through the arithmetic unit by comparing the current light intensity and the previous maximum intensity. If the current intensity is larger than the previous maximum intensity, the maximum intensity is replaced by the current intensity.

Example 33: The image sensor of example 32, wherein the time instant is obtained by using a time clock counter accompanied by each wise-pixel.

Example 34: The image sensor of example 33, wherein the compared intensities are analog signals.

Example 35: The image sensor of example 34, wherein the temporal maximum light intensity is stored as analog signal.

Example 36: The image sensor of example 35, wherein the temporal maximum intensity in each wise-pixel is stored as an analog signal in the circuit, e.g. capacitance. The analog signal is compared with the light intensity from the next valve modulation directly without ADC or DAC.

Example 37: The image sensor of example 33, wherein the temporal maximum light intensity and the corresponding time instant are stored as digital signals.

Example 38: The image sensor of example 37, wherein the renewed analog temporal maximum light intensity is converted to digital signal by ADC for storage, and then it is converted to analog signal by DAC for comparison in the next valve modulation.

Example 39: The image sensor of example 38, wherein each wise-pixel is further accompanied by a storage unit.

Example 40: The image sensor of example 39, wherein the wise-pixel records information in such a way that

(a) The maximum intensity of the incident light, e.g. the brightest light in all the valve modulations during a frame period is stored in the first storage unit;
(b) The time instant when the maximum intensity information is detected is stored in the second storage unit.

Example 41: The image sensor of example 40, wherein the storage units, the comparator and the ADC/DAC are located by each pixel inside the sensing area (pixel-based), behind the sensing area (multi-layer) or placed outside the sensing area (e.g. column-based).

Example 42: The image sensor of example 8, wherein the image sensor further comprises arithmetic units, e.g. a comparator and a time clock counter.

Example 43: The image sensor of example 42, wherein the comparator in each wise-pixel column compares the intensities of all the wise-pixels in the column in a valve modulation.

Example 44: The image sensor of example 43, wherein the maximum intensity in each wise-pixel column in a valve modulation is found by the comparator.

Example 45: The image sensor of example 44, wherein a threshold intensity is determined using the maxim intensity in each wise-pixel column in a valve modulation. For example, the threshold intensity is selected as a factor times the maximum intensity, where the factor is a number between 0 and 1.

Example 46: The image sensor of example 45, wherein for a valve modulation, the intensities and the corresponding time instants for all the wise-pixels whose intensity is larger than the selected threshold is exported.

Example 47: The image sensor of example 46, wherein the comparator, the time clock and the ADC/DAC are located by each pixel inside the sensing area (pixel-based), behind the sensing area (multi-layer) or placed outside the sensing area (e.g. column-based).

Example 48: A 3D imaging system comprising:

(a) One or more image sensors;

(b) A light source;

(c) One or more computing units;

### Wherein

(i) The image sensor comprises multiple wise-pixels;
(ii) Each wise-pixel is controlled in such a way that the response to light of each wise-pixel changes over time;
(iii) The wise-pixel records the information related to light illumination and time.

Example 49: The system of example 48, wherein the system further comprises:

(a) An optical lens;

(b) An optical filter;

Example 50: The system of example 48, wherein the light source illuminates the measured region with a beam of moving featured light.

Example 51: The system of example 49, wherein the shape of the featured light may be a curve or a line.

Example 52: The system of example 48, wherein the light can be laser or LED light.

Example 53: The system of example 48, wherein the light generated by the light source could be continuous or discrete light pulses.

Example 54: The system of example 49, wherein the wavelength of the light source matches with the passthrough wavelength of the filter.

Example 55: The system of example 48, wherein the light beam scans the measured area in a period.

Example 56: The system of example 48, wherein the sensor captures the light beams reflected from the measured area.

Example 57: The system of example 48, wherein the one or more computing units can calculate the 3D position of the featured light based on the time, which relates to the specific wise-pixel.

Example 58: A method of 3D shape reconstruction, wherein:

(a) The method comprises a 3D imaging system;

(b) The time information is extracted from image captured by the image sensor;

Wherein the 3D imaging system comprising:
(i) One or more image sensors;
(ii) A light source;
(iii) One or more computing units;

### Wherein

(A) The image sensor comprises multiple wise-pixels;

(B) Each wise-pixel is controlled in such a way that the response to light of each wise-pixel changes over time;

(C) The wise-pixel records the information related to light illumination and time.

Example 59: The method of example 58, further comprises computing 3D information using the extracted time information, wherein:

(a) Each wise-pixel has its specific time information connected with the light illumination;

(b) The light beam scans the measured area and matches with corresponding wise-pixels in the image sensors over time.

Example 60: The method of example 58, further comprises extracting the maximum intensity information from the image captured by the image sensor, wherein a certain wise-pixel can get the maximum intensity when the light beam moves to the corresponding 3D location.

Example 61: The method of example 58, further comprises computing 3D information using the extracted time information and intensity information, wherein the corresponding wise-pixels in different image sensors can be found. Each wise-pixel and camera center can form a pixel ray. The matching wise-pixel rays in different image sensors (two rays is enough) can intersect at a point. Then the 3D position of the point can be calculated according to the calibration information of image sensors.

Example 62: The method of example 58, further comprises computing 3D information using the extracted time information, wherein the surface plane of the incident light can be acquired from time information. Combined with the calibration information of the image sensor and light source, the wise-pixel ray may intersect with the surface plane of the incident light at a point. Then the 3D position of the point can be calculated.

A number of implementations have been described. Nevertheless, it will be understood that various modifications may be made without departing from the spirit and scope of the disclosure. Accordingly, other implementations are within the scope of the following claims.

What is claimed is:

1. An imaging method, comprising:
valve modulations in one or more wise-pixels in an image sensor during a frame period, wherein, a valve modulation is a one-time process of integrating the light and resetting;
high intensity selecting, by the one or more wise-pixels in multiple valve modulations, the intensities that is corresponding to bright light based on some certain conditions;
time instant outputting, by the one or more wise-pixels, the time information associated with the selected light intensity during the frame period.

2. The imaging method of claim 1, wherein the high intensity selecting is based on one or more of:
difference-based intensity comparison;
memory-based intensity comparison; or
threshold-based intensity extraction.

3. The imaging method of claim 2,
in a case of difference-based intensity comparison, high intensity selecting by the one or more wise-pixels comprising:
for each wise-pixel,
calculating the difference of intensity between the current valve modulation and the previous one;
detecting, by the wise-pixel, local maximum intensities of incident light based the difference of intensity; and
outputting the time instants of the wise-pixel when the local maximum is detected or outputting the time instants of the wise-pixel when the local maximum is detected along with the location of the wise-pixel, or outputting the time instants of the wise-pixel when the local maximum is detected along with the location of the wise-pixel and the local maximum intensity.

4. The method of claim 3, further comprising
when the signs of the two difference values change from positive to negative, and the absolute value of the two differences are larger than a certain value, the intensity of the pixel reaches the local maximum at the middle valve modulation.

5. The imaging method of claim 2,
in a case of memory-based intensity comparison, high intensity selecting by the one or more wise-pixels comprising:
for each wise-pixel,
comparing the current light intensity and the previous maximum intensity, if the current light intensity is larger than the previous maximum intensity, the maximum intensity is replaced by the current light intensity; and
outputting the time instant of the wise-pixel when the global maximum of the incident light is detected during a frame period, or outputting the time instant of the wise-pixel when the global maximum of the incident light is detected along with the globally maximum intensity during a frame period.

6. The method of claim 5, wherein
the temporal maximum intensity of the incident light in all the previous valve modulations during intensity-selection is stored in the first storage unit;
the time instant when the temporal maximum intensity information is detected is stored in the second storage unit.

7. The imaging method of claim 2,
in a case of threshold-based intensity comparison, light intensity selecting by the one or more wise-pixels comprising:
using a threshold to extract intensities for all the wise-pixels whose intensities are higher than the threshold at each valve modulation; and
outputting the time instant of the wise-pixel when the intensity is larger than the threshold during a frame period, or outputting the time instant when the selecting intensity is larger than the threshold along with the selecting intensity during a frame period.

8. The imaging method of claim 7, wherein the threshold is obtained by comparing the intensities of all the wise-pixels in the column in a valve modulation.

9. The imaging method of claim 8, wherein the threshold is determined using the maxim intensity in each wise-pixel column in a valve modulation.

10. The imaging method of claim 1, further comprising processing the wise-pixels row by row using column processing circuitries.

11. The imaging method of claim 10, further comprising:
buffering the data for AD conversion, wherein
the detected analog intensity is pushed into a buffer before converted into digital values; and
the length of the buffer may be less than the number of rows.

12. The method of claim 11, wherein the buffer works in such a way that once the lower layer of the buffer is empty, the data in the upper layer of buffer is pushed into the lower layer.

13. The imaging method of claim 10, further comprising:
buffering the data for I/O, wherein
the data are pushed into memory buffers before exporting; and
the length of the buffer may be less than the number of rows.

14. The image method of claim 1, further comprising:
storing the data generated during intensity selection using a storage unit, wherein
the storage unit is internal, wherein the storage unit is inside the area of pixel; or the storage unit is external, and a circuitry is used to access the memory;
the stored data is analog data, the data is converted to digital data only when the data is about to be outputted; or the stored data is digital data, additional ADC and/or DAC is used to store and/or access the data in the storage unit.

15. The image method of claim 1, further comprising:
in case that the selected intensity is converted to digital data, the intensity selection and AD conversion share a common device, so that intensity selection and AD conversion is operated simultaneously, wherein the AD conversion is SAR ADC.

16. An image sensor, wherein,
the image sensor comprises one or more wise-pixels, wherein the wise-pixels are controlled to integrate the light and reset by valve modulations multiple times in a frame period;
the image sensor selects high intensities based on some certain conditions during multiple valve modulations;
the image sensor exports time information when the selected intensities are detected during a frame period.

17. The image sensor of claim 16, wherein the intensity selection is based on one or more of:
difference-based intensity comparison;
memory-based intensity comparison; or
threshold-based intensity extraction.

18. The image sensor of claim 17,
in a case of difference-based intensity comparison, high intensity-selection by the one or more wise-pixels, comprising:
for each wise-pixel,
calculating the difference of intensity between the current valve modulation and the previous one;
detecting, by the wise-pixel, local maximum intensities of incident light based the difference of intensity; and
outputting the time instants of the wise-pixel when the local maximum is detected, or outputting the time instants of the wise-pixel when the local maximum is detected along with the location of the wise-pixel, or outputting the time instants of the wise-pixel when the local maximum is detected along with the location of the wise-pixel and the local maximum intensity.

19. The image sensor of claim 18, wherein
when the signs of the two difference values change from positive to negative, and absolute values of the two differences are larger than a certain value, the intensity of the pixel reaches the local maximum at the middle valve modulation.

20. The image sensor of claim 17,
in a case of memory-based intensity comparison, high intensity-selection by the one or more wise-pixels comprising:
for each wise-pixel,
comparing the current light intensity and the previous maximum intensity, if the current light intensity is larger than the previous maximum intensity, the maximum intensity is replaced by the current light intensity; and
outputting the time instant of the wise-pixel when the global maximum of the incident light is detected during a frame period, or outputting the globally maximum intensity of the wise-pixel along with the time instant when the global maximum of the incident light is detected during a frame period.

21. The image sensor of claim 20, wherein
the temporal maximum intensity of the incident light in all the previous valve modulations during intensity-selection is stored in the first storage unit;
the time instant when the temporal maximum intensity information is detected is stored in the second storage unit.

22. The image sensor of claim 17,
in a case of threshold-based intensity comparison, high intensity-selection by the one or more wise-pixels comprising:
using a threshold to extract intensities for all the wise-pixels whose intensities are higher than the threshold at each valve modulation; and
outputting the time instant of the wise-pixel when the intensity is larger than the threshold during a frame period, or outputting the time instant when the selecting intensity is larger than the threshold along with the selecting intensity during a frame period.

23. The image sensor of claim 22, wherein the threshold is obtained by comparing the intensities of all the wise-pixels in the column in a valve modulation.

24. The image sensor of claim 23, wherein the threshold is determined using the maxim intensity in each wise-pixel column in a valve modulation.

25. The image sensor of claim 17, wherein the image sensor processes the pixels row by row; intensity selection is based on the column processing circuitry.

26. The image sensor of claim 25, the column processing circuitry comprising:
a fast ADC architecture, wherein
the detected analog intensities are pushed into a buffer before they are converted into digital values; and
the length of the buffer may be less than the number of rows.

27. The image sensor of claim 26, wherein the buffer works in such a way that once the lower layer of the buffer is empty, the data in the upper layer of buffer is pushed into the lower layer.

28. The image sensor of claim 25, the column processing circuitry comprising:
a fast I/O architecture, wherein
the data are pushed into memory buffers before exporting; and
the length of the buffer may be less than the number of rows.

29. The image sensor of claim 16, wherein the image sensor further comprising:
a storage unit to store the data during intensity selection, wherein
(a) the storage unit is internal, i.e., the storage unit is inside the area of pixel; or the storage unit is external, and a circuitry is used to access the memory;
(b) the stored data is analog data, the data is converted to digital data only when the data is about to be outputted; or the stored data is digital data, external ADC and/or DAC is used to store and/or access the data in the storage unit.

30. The image sensor of claim 16, wherein the image sensor further comprising:
a processing circuitry, wherein the intensity selection and AD conversion share a common device, for example, SAR ADC, so that intensity selection and AD conversion is operated simultaneously.

31. An 3D imaging method, comprising:
calculating a geometry of an object scanned by featured light based on the information related to time instant or time instant along with locations and/or selected intensities of the wise pixels in one or more image sensor recited by claim 16;
time instant or time instant along with locations and/or selected intensities of the wise pixels are obtained according to the method of claim 1.

32. The method of claim 31, wherein calculating a geometry of an object scanned by featured light based on the information related to time instant or time instant along with locations and/or selected intensities of the wise pixels, comprising:
forming a pixel ray by each wise-pixel and camera center;
intersecting the matching wise-pixel rays in different image sensors at a point, or intersecting a matching wise-pixel ray with a surface plan of the incident light at a point; and
calculating the geometry position of the point according to the calibration information of image sensors.

33. A 3D imaging system, comprising:
one or more image sensors comprising one or more wise-pixels recited by claim 16-30;
one or more light sources;
one or more computing units;
wherein
the one or more wise-pixels and the one or more computing units are configured to perform the methods recited by claim 31.
